(19) United States
(12) Patent Application Publication
(10) Pub. No.: US 2024/0076189 A1
(43) Pub. Date: Mar. 7, 2024

(54) SYSTEM AND METHODS FOR GRAPHENE-BASED CATHODE MATERIAL

(71) Applicant: NEXTECH BATTERIES, INC., Carson City, NV (US)

(72) Inventors: Zachary FAVORS, Reno, NV (US); Dustin PATTERSON, Reno, NV (US); Fabio ALBANO, Reno, NV (US); Bill BURGER, Glenbrook, NV (US)

(21) Appl. No.: 18/262,165

(22) PCT Filed: Jan. 18, 2022
(86) PCT No.: PCT/US2022/070242

§ 371 Date: Jul. 19, 2023

Related U.S. Application Data
(60) Provisional application No. 63/139,261, filed on Jan. 19, 2021.

(51) Int. Cl. C01B 32/194

(52) U.S. Cl. CPC C01B 32/194; C01B 2204/22; C01P 2004/01; C01P 2006/40

(57) ABSTRACT

A composition comprising an active material and method for forming the same. The method for manufacturing an active material can include preparing one or more polychalcogen containing liquids, preparing a graphene nanoplatelet containing liquid, preparing an organic acid liquid, and mixing the various liquids, which can be in the form of liquids, suspensions or emulsions, to form a mixture. Additionally, the method can include filtering the mixture to produce a filtrate, and drying the filtrate to produce the active material.

This application claims priority to U.S. Application No. 63/139,261, filed Jan. 19, 2021, and is incorporated herein in its entirety.

### TECHNICAL FIELD

The specification relates generally to the field of rechargeable batteries, including active material for a lithium-sulfur battery cathode.

### BACKGROUND

Multiple chemistries have been proposed for rechargeable batteries, for example, Nickel-Cadmium, Lithium-ion, and Lithium-Sulfur (L-S) batteries. With the increasing prevalence of battery-powered vehicles and mobile devices, there is a need for a high-endurance, lightweight, efficient, and inexpensive battery that can be reliably manufactured at scale. Lithium-Sulfur batteries are of particular interest because they have an extremely high specific capacity of about 1675 mAh g⁻¹ and high specific energy of about 600 Wh kg⁻¹. Unlike cobalt, which is relatively rare, sulfur is abundant, readily available, and inexpensive. Sulphur is also non-toxic, making it relatively easy to employ as a cathode material.

Despite these advantages, sulfur is highly resistive. This makes sulfur, without the addition of other conductive materials, challenging as a cathode material. To overcome this resistance, work has been done to mix highly conductive graphene, from reduced graphene-oxide, with sulfur to overcome sulfur's electrical resistivity.

Limiting these traditional approaches, graphene is extremely hydrophobic. As a result, it is difficult to uniformly mix into a slurry. Although graphene-oxide does not exhibit the same hydrophobic properties as graphene, the process of reducing graphene-oxide to graphene is expensive, unpredictable, and subject to high degrees of variability. Graphene formed from reduced graphene oxide often fails to reliably produce useful graphene-sulfur active material, resulting in substantial unpredictability, unreliability of the process, high-cost, poor scalability, and wasted resources, often because of unwanted impurities typically found in the graphene formed from reduced graphene oxide.

The use of graphene oxide based active material results in very long and unpredictable synthesis times. This is likely due to the non-uniform and random nature of graphene oxide. The acidification reaction where sulfur nanoparticles are formed and are adsorbed to the surface of graphene oxide is affected by the specific properties of the graphene oxide present. Due to this, synthesis times can range from 3 hrs to 24 hrs depending on the specific nature of the graphene oxide present in that batch. The literature which describes making sulfur graphene oxide composites for Li—S batteries claim to obtain a sulfur reduced graphene oxide product. Yet, there is very little evidence in the Li—S battery literature to support that any sulfur species during the synthetic process is reducing graphene oxide. Typical evidence, if any, of a carbon sulfur bond being formed between sulfur and graphene oxide is XPS spectroscopy, which has limitations when analyzing non-homogenous materials. Additionally, there are no examples in the chemical literature that show or suggest that a covalent bond between sulfur and oxygen functionalized graphitic carbon could form under the synthetic conditions proposed in the Li—S battery literature.

Aspects of this specification address these problems by providing an active material and a method for manufacturing the active material.

### SUMMARY

In an example method, there is described a method for manufacturing an active material can include a method for manufacturing an active material comprising: preparing one or more polychalcogen containing liquids; preparing a graphene nanoplatelet containing liquid; preparing an acid-based liquid; mixing at least one of the polychalcogen containing liquid, the graphene nanoplatelet containing liquid, and the acid-based liquid into a uniform mixture; filtering the mixture to produce a filtrate; and drying the filtrate to produce an active material comprising a dry powder.

There is also disclosed an active material made according to the method described herein, and comprising a chalcogen, and graphene nanoplatelets.

Additionally, or alternatively, preparing the polychalcogen liquid can include mixing a quantity of a chalcogen and/or a quantity of a chalcogen salt with a quantity of water to make a precursor polychalcogen liquid, heating the precursor polychalcogen liquid to a predetermined temperature; and stirring the precursor polychalcogen liquid for a predetermined time to form the polychalcogen liquid.

Additionally, or alternatively, the polychalcogen liquid can be a polysulfide liquid; and the chalcogen can be sulfur.

Additionally, or alternatively, the polychalcogen liquid can be a polytellurium liquid; and the chalcogen can be tellurium.

Additionally, or alternatively, the polychalcogen liquid can be a polyselenium liquid; and the chalcogen can be selenium.

Additionally, or alternatively, the polychalcogen liquid can be a combination of two or more of the above polychalcogen liquids.

Additionally, or alternatively, preparing the graphene nanoplatelet suspension can include mixing a quantity of graphene nanoplatelets with a quantity of water to make a precursor graphene nanoplatelet suspension, heating the precursor graphene nanoplatelet suspension to a predetermined temperature, and sonicating the precursor graphene nanoplatelet suspension for a predetermined amount of time to form the graphene nanoplatelet suspension.

Additionally, or alternatively, preparing an organic acid liquid (e.g., citric acid liquid) can include dissolving a quantity of organic acid (e.g., citric acid) in a quantity of water to make a quantity of organic acid liquid, cooling the organic acid liquid to a predetermined temperature, and adding a second quantity of cold water to the organic acid liquid to make a second quantity of organic acid liquid.

Additionally, or alternatively, mixing the polychalcogen liquid, the graphene nanoplatelet suspension, and the organic acid liquid with ethylenediamine and ethanol to form the mixture can include cooling a quantity of water to a predetermined temperature, mixing in the graphene nanoplatelet suspension with the quantity of water to form a first mixture, mixing in the polychalcogen liquid with the first mixture to form a second mixture, mixing in the ethylene diamine with the second mixture to form a third mixture, mixing in the ethanol with the third mixture to form a fourth mixture, determining that a temperature of the fourth mixture is within a predetermined temperature range, and mixing in the organic acid liquid to the fourth mixture to form a fifth mixture.

Additionally, or alternatively, filtering the mixture to produce the filtrate can include draining the mixture into a Buchner funnel to produce a first filtrate, and rinsing the first filtrate with water until effluent water generated by the rinsing is within a predetermined pH range forming the filtrate.

Additionally, or alternatively, drying the filtrate to produce the active material can include placing the filtrate in an oven for a predetermine time and/or at a first predetermined temperature, and heat treating the filtrate by placing the filtrate in a furnace for a predetermined time and/or at a second predetermined temperature forming the active material, wherein a gas composition within the furnace is substantially argon.

In an example active material, the active material can include one or more of: a chalcogen, graphene nanoplatelets, and an amine.

Additionally, or alternatively, the graphene nanoplatelets and/or the chalcogen can form a complex with the amine.

Additionally, or alternatively, the complex can be granted using a noncovalent interaction between ammonium and at least one of: the graphene nanoplatelets and the chalcogen.

Additionally, or alternatively, the graphene nanoplatelets can be uniformly dispersed throughout the active material.

Additionally, or alternatively, the uniform dispersion of the graphene nanoplatelets can be driven by the amine complexed with the chalcogen.

Additionally, or alternatively, a concentration of chalcogen within the active material can be between 30% and 95% by weight.

Additionally, or alternatively, a concentration of the graphene nanoplatelets can be between 5% and 70% by weight.

Additionally, or alternatively, the chelating agent (ethylenediamine) can include at least one of various amines (diamines, triamines, tetramines) or aminocarboxylic acids (APCA), examples include: EDA, cadaverine, putrescine, EDTA, DTPA, and EDDS.

Additionally, or alternatively, a particle size range of the chalcogen can be between 1 nm and 100 nm.

Additionally, or alternatively, a particle size range of the graphene nanoplatelets can be between 1 μm and 1,000 μm.

Additionally, or alternatively, the chalcogen can be sulfur.

Additionally, or alternatively, the chalcogen can include a dopant, the dopant can include one or more of: tellurium or selenium.

Additionally, or alternatively, a concentration of the dopant can be between 1% to 10% by weight.

Both the foregoing general summary and the following detailed description are exemplary and do not restrict the invention, as claimed.

### BRIEF DESCRIPTION OF THE DRAWINGS

The accompanying drawings, which are incorporated in and constitute a part of this specification, illustrate embodiments and, together with the description, serve to explain the principles of the invention.

FIG. 1 is a flowchart of a prior art method for manufacturing an active material.

FIG. 2A is a flowchart of a method for manufacturing an active material, according to embodiments of the present disclosure.

FIGS. 2B and 2C is a micrograph of an active material manufactured from the manufacturing process of FIG. TA.

FIG. 3 is a flowchart of an example method of manufacturing an active material, according to examples.

FIG. 4 is a flowchart of an example method of manufacturing a polychalcogen liquid according, to examples.

FIG. 5 is a flowchart of an example method of manufacturing a graphene nanoplatelet suspension according, to examples.

FIG. 6 is a flowchart of an example method of manufacturing an organic acid liquid, according to examples.

FIG. 7 is a flowchart of an example method of manufacturing an active material mixture, according to examples.

FIG. 8 is a flowchart of an example method of manufacturing a filtrate from the active material mixture, according to examples.

FIG. 9 is a flowchart of an example method of manufacturing an active material from a filtrate, according to examples.

FIG. 10A is a micrograph of active material before additional processing, according to examples.

FIG. 10B is a micrograph of active material after additional processing, according to examples.

FIG. 11A is a micrograph of selenium-doped active material before additional processing, according to examples.

FIG. 11B is a micrograph of selenium-doped active material after additional processing, according to examples.

FIG. 12 is a graph illustrating a relationship between specific energies and c-rates of a graphene-oxide active material and a graphene nano-platelet active material, according to examples.

FIG. 13 is a graph illustrating a relationship between formation capacity and voltage of a graphene nano-platelet active material and a selenium-doped graphene nano-platelet active material, according to examples.

### DETAILED DESCRIPTION

Embodiments of the present disclosure include a process for making, as well as resulting material composition suitable for use as an active material. The active material can be a cathode active material, more specifically, the active material can include graphene nanoplatelets, an amine chelating agent, and a chalcogen. A graphene nanoplatelet can be defined as a graphitic particle that is a substantially flat stack of graphene sheets, with a thickness (z) in the order of nanometers, typically less than 100 nm, and lateral sizes (x, y) greater than the thickness. The graphene nanoplatelets can include high single layer content, for example, at least 95% of the graphene nanoplatelets may be single layer nanoplatelets. The graphene nanoplatelets can include a high degree of crystallinity (e.g., low number of defects). The graphene nanoplatelets can be hydrophilic, resulting in improved dispersion during manufacture of a graphene nanoplatelet suspension.

In one embodiment, the graphene nanoplatelet described herein has a lower impurity content than graphene formed from reduced graphene oxide. Impurities, as used herein, exclude: chalcogens (e.g., sulfur, selenium, tellurium); pristine, graphitic, and platelet-like graphene; and amines.

The amine chelating agent can include at least one of EDA; EDTA; cadaverine; putrescine; diamines; or triamines. The chalcogen can include at least one of sulfur (S); tellurium (Te); or selenium (Se). Chalcogens are typically poor electrical conductors, hence a dopant may be included in the active material to improve the electrical conductivity of the active material. Sulfur in particular is a very poor electrical conductor, and adding other chalcogens like Te or Se, which are more performant electrical conductors relative to Sulfur, can improve the electrical conductivity of the active material, a desirable property for a battery active material. The dopant can include at least one of: tellurium, selenium, antimony, arsenic, phosphorus, germanium, other p-block elements, transition metal oxides, transition metal sulfides, or transition metal nitrides.

In an example, the dopant can be electroactive while increasing the electrical conductivity of the active material. Additionally, low-order lithium-polysulfides are generally insoluble in typical electrolyte solvents (such as DME, DOL, TTE, BTFE). Incorporation of Te or Se into the polysulfide backbone creates polar bonds as well as a more overall polarizable molecule when compared to polysulfides. This results in increased solubility. This increased solubility through the addition of Te or Se can lower the activation energy for an oxidation state change and speed up conversion of polychalcogenides from higher order to lower order within the cell.

The active material can be applied to an electrically conductive base that include at least one of: copper or aluminum. The active material can be used in a solid-state battery including a “solid” (e.g. highly viscous) electrolyte, or a “wet” battery utilizing a liquid electrolyte. Without wishing to be bound by theory, it is expected that non-sulfur chalcogens can improve the kinetics of the sulfur conversion reactions.

The “liquids” described and claimed herein are meant to include liquids, suspensions, emulsions, or combinations thereof. For example, the description of a polychalcogen containing liquid is intended to encompass polychalcogen containing liquids, suspensions, emulsions, or combinations thereof. Similarly, the description of a graphene nanoplatelet containing liquid is intended to encompass graphene nanoplatelet containing liquids, suspensions, emulsions, or combinations thereof. Also, the description of an acid-based liquid is intended to encompass acid-based liquids, suspensions, emulsions, or combinations thereof.

The method of manufacturing the active material can include preparing one or more polychalcogen liquids, preparing a graphene nanoplatelet suspension, and preparing an organic acid liquid. The preparations need not be performed in a specific order and can be performed simultaneously.

For mixing the liquids and suspensions, the method can include mixing at least the polychalcogen liquid, the graphene nanoplatelet suspension, and the organic acid liquid to form a mixture. The mixing can include the addition of other materials, such as, ethanol and/or ethylene diamine.

For filtering and drying the mixture, the method can filter the mixture to produce a filtrate and dry the filtrate to produce the active material.

To facilitate a better understanding of the specification, the following exemplary embodiments are provided. The following embodiments are not to be read to limit or define the scope of the specification. Embodiments and their advantages are best understood by reference to the figures, where like numbers are used to indicate like and corresponding parts.

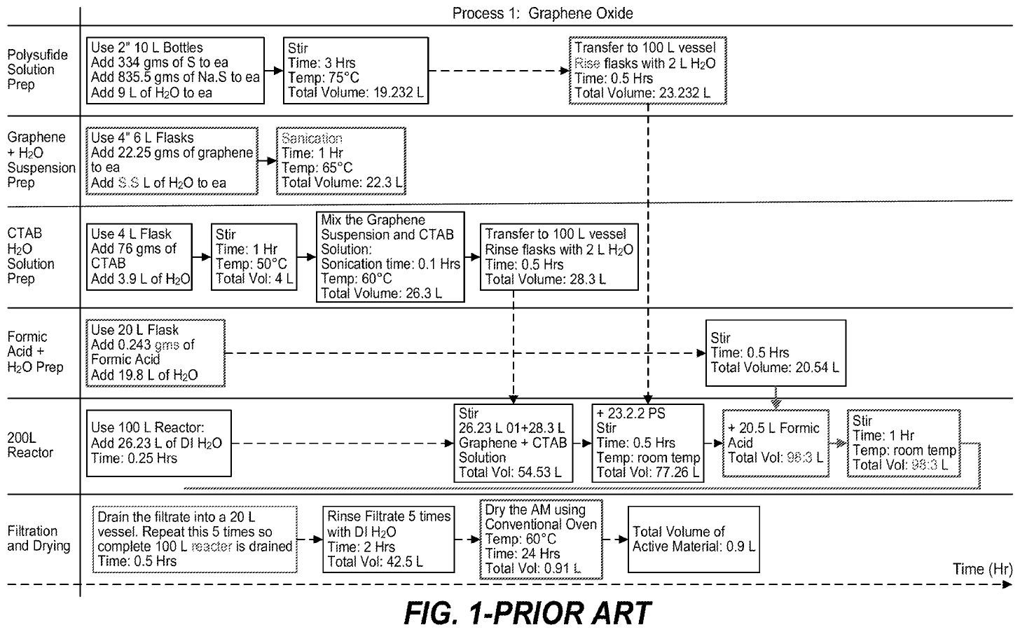

FIG. 1 is a flowchart depicting a prior art method for a prior art lithium-sulfur cathode material.

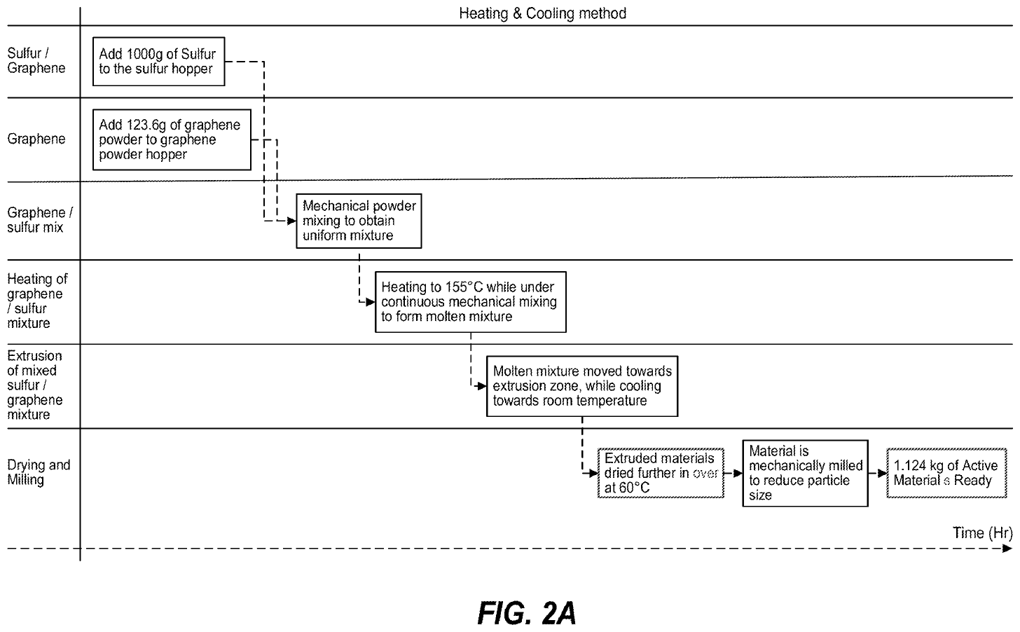

FIG. 2A is a flowchart illustrating a method for heating and cooling material, according to embodiments of the present disclosure.

In an embodiment, the method can produce an electro-active sulfur-graphene composite material (e.g., active material). The method can include mechanical mixing of one or more powders, and then heat treating one or more powders at an elevated temperature.

The one or more powders can include sulfur and/or graphene nanoplatelets. Sulfur, preferably of purities of 99.9% sulfur or higher, can be used as a starting material, preferably in micron-size particle size of −200 mesh or smaller. Sulfur can be added to 1 or more carbon materials, such as graphene nanoplatelets, in a pre-determined ratio, preferably 88:12 by mass. The sulfur and graphene nanoplatelets can be placed into a milling container, such as a ball mill made of yttria-stabilized zirconia, which can be run for a pre-determined time to further reduce particle size and to mix the two powders into a homogenous mixture.

Afterwards, this mixed powder can be heat treated to allow the sulfur to melt and diffuse onto the carbon surface, which can be accomplished by heating the mixture to the minimum viscosity point of sulfur at about 155° C. The resulting active material can include a sulfur-carbon composite material, wherein sulfur is bonded to the surface of the carbon by melting.

FIGS. 2B and 2C are mircographs of active material produced from the method of FIG. 2A, according to embodiments of the present disclosure.

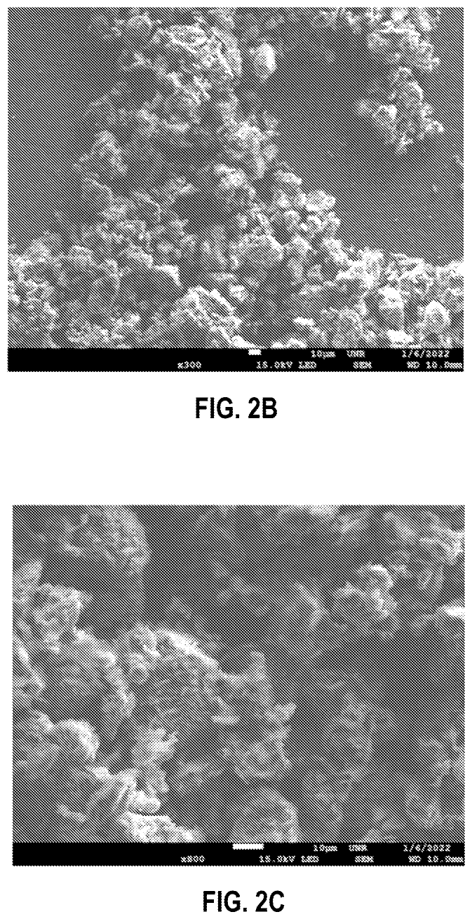

FIG. 3 is a flowchart of an example method 100 of manufacturing the active material according to examples. The method 100 can include a method 200 for preparing one or more polychalcogen liquids, a method 300 for preparing a graphene nanoplatelet suspension, a method 400 for preparing an organic acid liquid, a method 500 for mixing liquids and/or suspensions to form a mixture, a method 600 for filtering the mixture to form a filtrate, and a method 700 for drying the filtrate to form an active material.

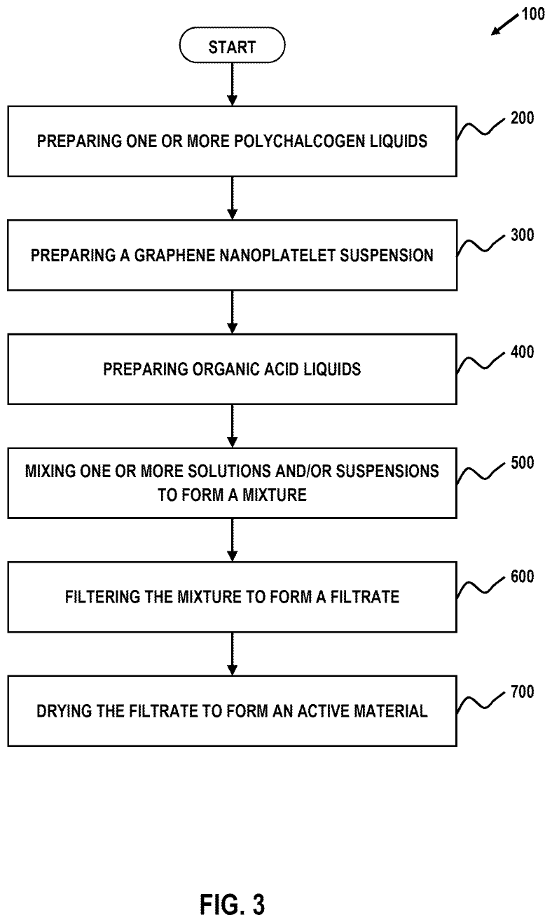

FIG. 4 is a flowchart of an example method of manufacturing one or more polychalcogen liquids. At block 202, the method 200 can include mixing a quantity of a chalcogen and/or a quantity of a chalcogen salt with a quantity of water to make one or more precursor polychalcogen liquids. In an example, the chalcogen can include sulfur. In an example, the first polychalcogen liquid can include a polysulfide liquid. The quantity of chalcogen can be approximately 291 g. Alternatively, the quantity of chalcogen can be within a range between 100 g to 312 g. The quantity of chalcogen salt can be approximately 750 g. Alternatively, the quantity of chalcogen salt can be within a range between 258 g to 804 g. The quantity of water can be approximately 5 L. Alternatively, the quantity of water can be within a range between 1 L to 10 L.

Additionally, or alternatively, block 202 can further include manufacturing a second polychalcogen liquid. The chalcogen can include at least one of: tellurium or selenium. Additionally, or alternatively, the second polychalcogen liquid can include at least one of: a polytellurium liquid or a polyselenium liquid. Manufacturing the second polychalcogen liquid can include adding approximately 637.16 g of Na₂SeO₃ to about 2.5 L of deionized water. The quantity of deionized water can be within a range of 2 L to 3 L.

At block 204, the method 200 can include heating the first polychalcogen liquid to a predetermined temperature and stirring the first polychalcogen liquid for a predetermined time. The predetermined temperatures for heating can be 70° C. Additionally, or alternatively, the predetermined temperatures for heating can be 40° C. Alternatively, the predetermined temperature for heating can be within a range between 40° C. to 70° C. The predetermined time for stirring and/or heating can be about 3 hours (hrs). Alternatively, the predetermined time for stirring and/or heating can be within a range between from 3 hrs to 15 hrs.

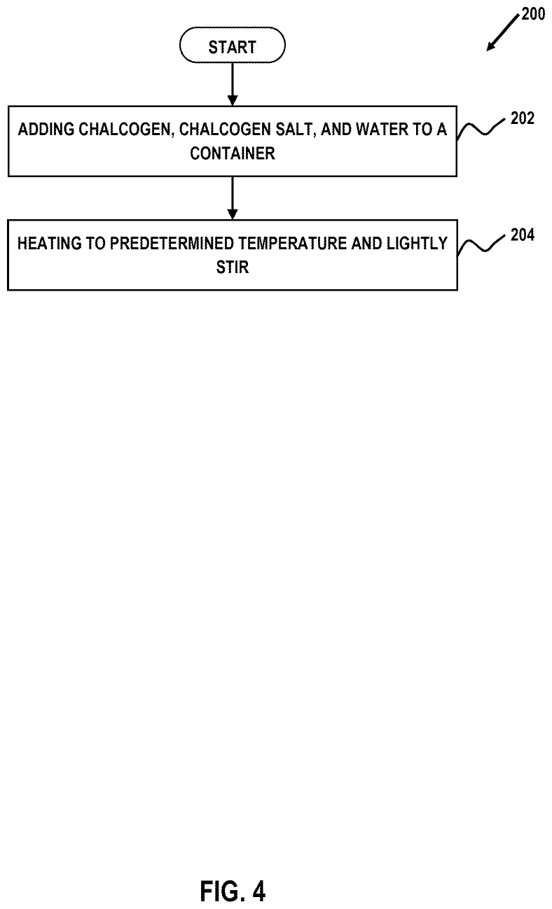

FIG. 5 is a flowchart of an example method of manufacturing a graphene nanoplatelet suspension. At block 302, the method 300 for preparing a graphene nanoplatelet suspension can include mixing a quantity of graphene nanoplatelets, with an approximate particle size diameter having a d10 of 1.3 μm and a d90 of 9 μm and an apparent density within a range between 40 g/L to 90 g/L, with a quantity of water to make a precursor graphene nanoplatelet suspension. The quantity of graphene nanoplatelets can be approximately 200 g. Alternatively, the quantity of graphene nanoplatelets can be within a range between 67.54 g (e.g., 30% by weight sulfur of the graphene sulfur composite) and 214.2 g (e.g., 95% by weight sulfur of the graphene sulfur composite). The quantity of water can be approximately 4 L. Alternatively, the quantity of water can be within a range between 1 L to 10 L.

At block 304, the method 300 for preparing a graphene nanoplatelet suspension can include heating the precursor graphene nanoplatelet suspension to a predetermined temperature. The predetermined temperature for heating can be 40° C. The predetermined temperature for heating can be 70° C. Alternatively, the predetermined temperature for heating can be within a range between 40° C. to 70° C. Additionally, the precursor graphene nanoplatelet suspension can be heated and/or stirred for a predetermined time. The predetermined time for stirring and/or heating can be about three hours. Alternatively, the predetermined time for stirring and/or heating can be within a range between 3 hrs to 15 hrs.

At block 306, the method 300 for preparing a graphene nanoplatelet suspension can include high energy and/or shear techniques including sonicating the precursor graphene nanoplatelet suspension (at a frequency within the range of 20 kHz to 100 kHz, such as at 35 kHz) for a predetermined amount of time to form the graphene nanoplatelet suspension. The predetermined amount of time for sonicating can be approximately 3 hrs. Alternatively, the predetermined time for sonicating can be within a range between 1 hrs to 5 hrs. The heating of block 304 and sonication can be performed simultaneously. Alternatively, the heating and sonication can be performed independently. The graphene nanoplatelet suspension can be sonicated using an ultrasonic transducer. The ultrasonic transducer can be submerged within the suspension. Additionally, or alternatively, the ultrasonic transducer can be in communication with a retaining vessel containing the graphene nanoplatelet liquid. Other high energy or high shear techniques can include at least one of: bath sonication, probe sonication, cavitation, ball milling, or stirring.

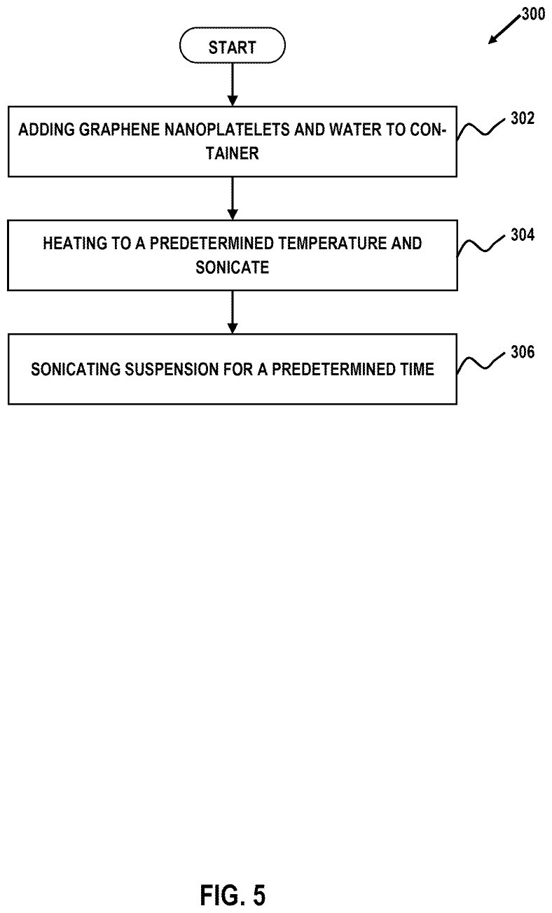

FIG. 6 is a flowchart of an example method of manufacturing an organic acid liquid. At block 402, the method 400 for preparing an organic acid liquid can include adding a quantity of organic acid in a quantity of water to make a quantity of organic acid liquid. The quantity of water can be approximately 2.5 L. Alternatively, the quantity of water can be within a range between 0.1 L to 20 L. Alternatively, the quantity of water can be 0 L. The quantity of organic acid can be approximately 1875 g. Alternatively, the quantity of organic acid can be within a range between 5625 g to 1875 g.

At block 404, the method 400 for preparing an organic acid liquid can include dissolving a quantity of organic acid in a quantity of water to make a quantity of organic acid liquid. Dissolving the quantity of organic acid into the quantity of water can include stirring the liquid for a predetermined amount of time. The predetermined amount of time for stirring can be approximately 30 minutes. Alternatively, the predetermined time for stirring can be within a range between 1 hrs to 5 hrs.

At block 406, the method 400 for preparing an organic acid liquid can include cooling the organic acid liquid to a predetermined temperature. The predetermined temperature for cooling can be approximately 4° C. Alternatively, the predetermined temperature for cooling can be within a range between 4° C. to 40° C.

At block 408, the method 400 for preparing a organic acid liquid in the range between 1 L to 120 L can include adding a second quantity of cold water (within a temperature range of 5° C.-22° C.) to the organic acid liquid to make a second quantity of organic acid liquid that is sufficient to complete the reaction. The second quantity of cold water can be approximately 15 L. Alternatively, the second quantity of cold water can be within a range between 1 L to 120 L. Alternatively, cold water need not be added to the organic acid liquid. The quantity of organic acid liquid can be a quantity sufficient to facilitate the reactions, as would be understood by one of skill in the art.

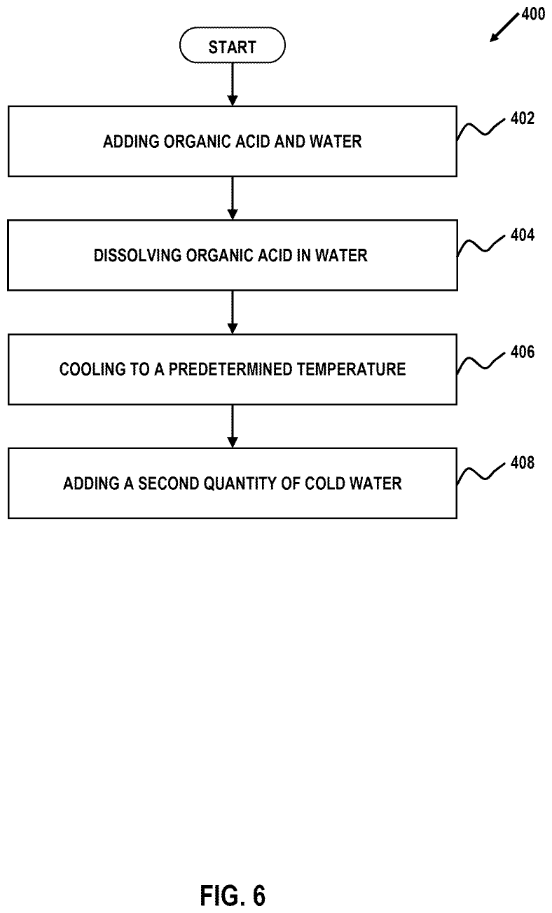

FIG. 7 is a flowchart of an example method of manufacturing an active material slurry. At block 502, the method 500 for mixing liquids and/or suspensions to form a mixture can include adding room temperature water to a container.

At block 504, the method 500 for mixing one or more liquids and/or suspensions to form a mixture can include cooling a quantity of water to a predetermined temperature. The predetermined temperature for cooling can be approximately 4° C. Alternatively, the predetermined temperature for cooling can be within a range between 4° C. to 40° C. The quantity of water can be approximately 13 L. Alternatively, the quantity of water can be within a range between 0.1 L to 100 L. Alternatively, the quantity of water can 0 L.

At block 506, the method 500 for mixing one or more liquids and/or suspensions to form a mixture can include adding the graphene nanoplatelet suspension. The addition can include mixing using at least one of: a magnetic stirrer, an impeller, overhead mixer, shaker table, or sonication in the graphene nanoplatelet suspension with the quantity of water to form a first mixture. The RPM of stirring/mixing can be within the range of 25 rpm to 600 rpm, such as 120 rpm.

At block 508, the method 500 for mixing one or more liquids and/or suspensions to form a mixture can include adding the first polychalcogen liquid. The addition can include mixing using at least one of: a magnetic stirrer, an impeller, overhead mixer, shaker table, or sonication in the first polychalcogen liquid with the first mixture to form a second mixture.

Additionally, or alternatively, block 508 can further include adding the second polychalogen liquid. The addition can include mixing using at least one of: a magnetic stirrer, an impeller, overhead mixer, shaker table, or sonication.

At block 510, the method 500 for mixing one or more liquids and/or suspensions to form a mixture can include adding one more amine chelating agent to the second mixture at a first predetermined time. Additionally, or alternatively, the method 500 can include mixing in ethylene diamine (EDA) with the second mixture to form a third mixture. Additionally, or alternatively, the chelating agent (e.g., ethylenediamine) can include at least one of various amines (e.g., diamines, triamines or tetramines) or aminocarboxylic acids (APCA), examples include: EDA, cadaverine, putrescine, EDTA, DTPA, and EDDS. The first predetermined time can be approximately 15 minutes after the quantity of water cools to the predetermined temperature. Additionally or alternatively, the first predetermined time can be within a range between 0.1 minutes to 30 minutes after the quantity of water cools to the predetermined temperature. The quantity of EDA added can be approximately 0.99 L. Alternatively, the quantity of EDA added can be within a range between 0.25 L to 2.5 L.

At block 512, the method 500 for mixing one or more liquids and/or suspensions to form a mixture can include adding one more alcohols at a second predetermined time. Additionally, or alternatively, the method 500 can include mixing in ethanol with the third mixture to form a fourth mixture. The one or more alcohols can be at least one of: ethanol, methanol isopropanol butanol, or t-butyl alcohol. The second predetermined time can be approximately 20 minutes after the quantity of water cools to the predetermined temperature. Additionally, or alternatively, the second predetermined time can be within a range between 0.1 to 120 minutes after the quantity of water cools to the predetermined temperature. The quantity of ethanol added can be approximately 2.49 L. Alternatively, the quantity of ethanol added can be between 0.1 L to 10 L. Alternatively, no ethanol may be added.

At block 514, the method 500 for mixing one or more liquids and/or suspensions to form a mixture can include determining that a temperature of the mixture is within a predetermined temperature range and adding the organic acid liquid responsive to the determination. Additionally, or alternatively, the method 500 can include mixing in the organic acid liquid to the fourth mixture to form a fifth mixture. The predetermined temperature range can be within a range between 5° C. to 7° C. Additionally, or alternatively, the predetermined range can be within a range between 4° C. to 40° C.

At block 516, the fifth mixture can remain without further processing for a predetermined amount of time to facilitate the reactions within the fifth mixture. The predetermined amount of time can be within a range of 1 hrs to 24 hrs.

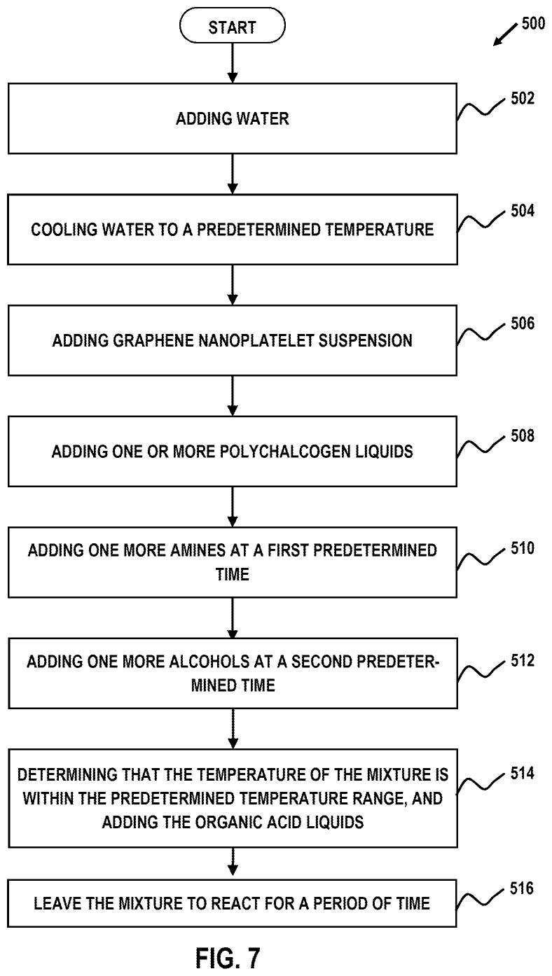

FIG. 8 is a flowchart of an example method of manufacturing a filtrate from the active material slurry. At block 602, the method 600 for filtering the mixture to form a filtrate can include draining the mixture into a Buchner funnel using at least one of: a peristaltic pump or vacuum pump to produce a first filtrate. Additionally, the mixture can be filtered using at least one of a gravity filter, disc filter, filter press, centrifuge filter, or Nutsche filter.

At block 604, the method 600 for filtering the mixture to form a filtrate can include rinsing the first filtrate with water until effluent water generated by the rinsing is within a predetermined pH range forming the filtrate. The predetermined pH range can be within a range between 6 to 8. The predetermined pH can be approximately 7.

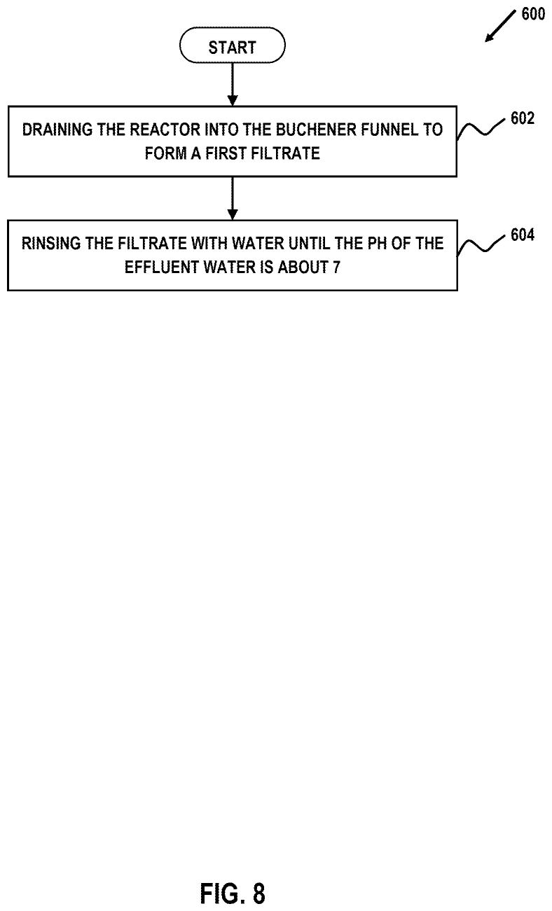

FIG. 9 is a flowchart of an example method of manufacturing an active material from a filtrate. At block 702, the method 700 for drying the filtrate to form an active material can include placing the rinsed filtrate in an oven for a predetermine time and/or at a first predetermined temperature. The predetermined time can be approximately 12 hrs. Alternatively, the predetermined time can be within a range between 6 hrs to 24 hrs. The predetermined temperature can be approximately 65° C. Alternatively, the predetermined temperature can be within a range between 4° C. to 80° C.

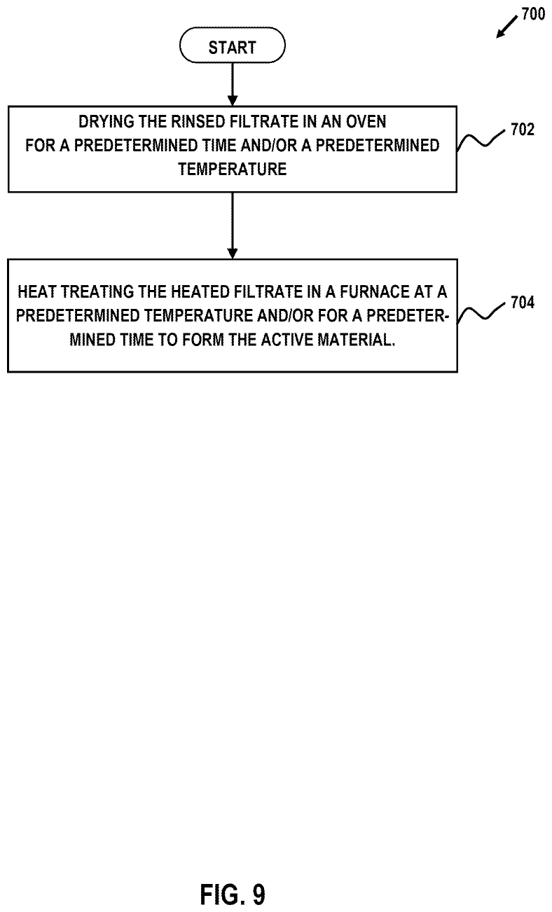

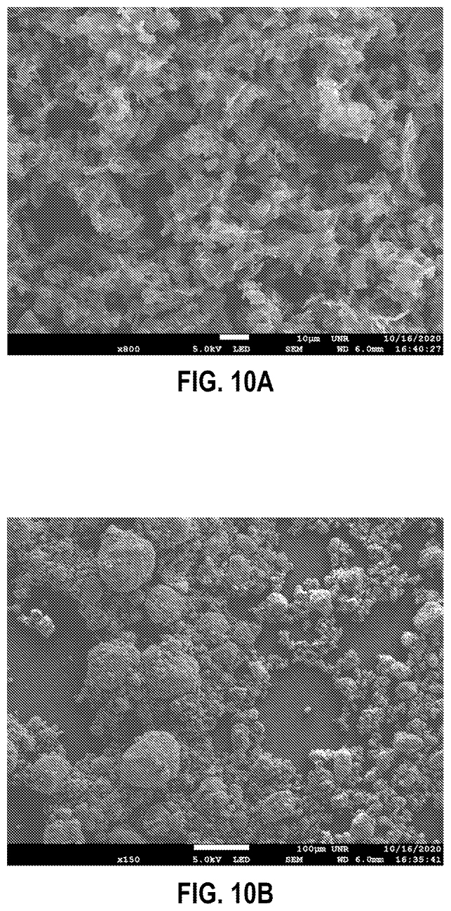

Turning to FIG. 10A, the micrographs illustrate the resulting active material comprising graphene nanoplatelets. Turning to FIG. 11A, the micrograph illustrates the resulting selenium-doped active material comprising graphene nanoplatelets.

Turning back to FIG. 9, at block 704, the method 700 for drying the filtrate to form an active material can include heat treating the heated filtrate in a furnace at a predetermined temperature and/or for a predetermined time to produce the active material. The predetermined time can be approximately twelve-hours. Alternatively, the predetermined time can be within a range between 1 hrs to 16 hrs. The predetermined temperature can be approximately 155° C. Alternatively, the predetermined temperature can be within a range between 125° C. to 160° C. Additionally, or alternatively, a gas composition within the furnace is substantially argon or another inert gas such as N2 or He.

Turning to FIG. 10B, the micrograph illustrates the resulting active material comprising graphene nanoplatelets. Turning to FIG. 11B, the micrograph illustrates the resulting selenium-doped active material comprising graphene nanoplatelets.

The method 100 can approximately yield between 2.8 kg and 3.2 kg of active material.

In an example, the resulting active material can include a chalcogen, graphene nanoplatelets, and an amine. Additionally, the graphene nanoplatelets and/or the chalcogen can form a complex with the amine. Additionally, or alternatively, the complex is granted using a noncovalent interaction between ammonium and at least one of the graphene nanoplatelets and the chalcogen. Additionally, or alternatively, the active material can include a concentration of chalcogen between 30% and 95% by weight. Additionally, the particle size range of the chalcogen can be between 1 nm and 100 nm. Additionally, or alternatively, the active material can include a concentration of the graphene nanoplatelets within a range between 5% and 70% by weight. Additionally, or alternatively, the particle size range of the graphene nanoplatelets can be within a range between 1 and 1000 um. In an example, the graphene nanoplatelets can be uniformly dispersed throughout the active material. Additionally, the uniform dispersion of the graphene nanoplatelets can be driven by the amine complexed with the chalcogen. In another example, the graphene nanoplatelets can be decorated with the amine. In an example, the chalcogen can be sulfur. Additionally, the chalcogen can be doped with tellurium and/or selenium, transition metals, transition metal compounds, and appropriate p-block elements such as Arsenic, Antimony, Phosphorus, or Germanium. The concentration of the dopant can be between 1% to 10% by weight.

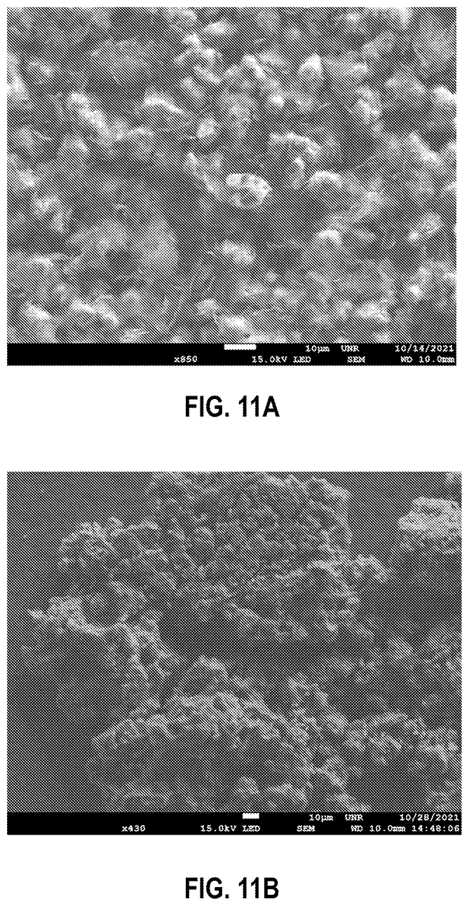

Examples disclosed in the specification have multiple technical effects. Turning to FIG. 12, which illustrates a domain of specific energies with respect to a range of discharge C-rate for a graphene-oxide active material and a graphene nanoplatelet active material. The graphene nanoplatelet active material can substantially mirror the performance of the graphene-oxide active material, deliver substantially similar specific energy within a range of C-rate discharge rates, wherein the range can be from C/20 to C/2 discharge rates. Advantageously, graphene nanoplatelets can be produced at less than a tenth the cost of graphene oxide, as a result of lower manufacturing costs. In other words, the $/kWh for each kilogram of produced graphene nanoplatelet active material can be less than a tenth the cost of graphene oxide active material.

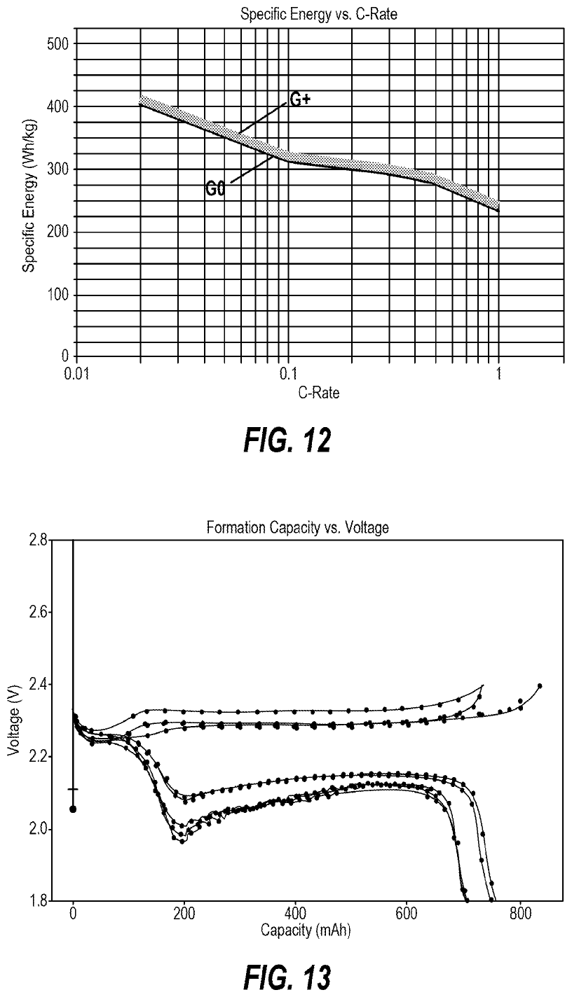

FIG. 13 illustrates charge and discharge voltage curves for selenium-doped graphene nanoplatelet active material and graphene oxide active material. As shown, the selenium-doped graphene nanoplatelet active material can produce a higher nominal cell discharge voltage at C-rates from C/20 up to 1° C. continuous discharge and lower polarization with increasing discharge C-rate. FIG. 13 further illustrates charge and discharge voltage curves for graphene nanoplatelet active material, which shows much higher polarization in the discharge voltage profiles with increasing C-rate.

It is appreciated that certain features of the specification, which are, for clarity, described in the context of separate embodiments, can also be provided in combination in a single embodiment. Conversely, various features of the specification, which are, for brevity, described in the context of a single embodiment, can also be provided separately or in any suitable subcombination or as suitable in any other described embodiment of the specification. Certain features described in the context of various embodiments are not essential features of those embodiments, unless noted as such.

All concentrations provided as percentages are by weight, unless otherwise noted.

Although the specification has been described in conjunction with specific embodiments, many alternatives, modifications and variations can be apparent to those skilled in the art. Accordingly, the following claims embrace all such alternatives, modifications, and variations that fall within the terms of the claims.

What is claimed is:

1. A method for manufacturing an active material comprising:
preparing a polychalcogen containing liquid;
preparing a graphene nanoplatelet containing liquid;
preparing an acid-based liquid;
mixing at least one of the polychalcogen containing liquid, the graphene nanoplatelet containing liquid, and the acid-based liquid into a uniform mixture;
filtering the mixture to produce a filtrate; and
drying the filtrate to produce an active material comprising a dry powder.

2. The method of claim 1, wherein preparing the polychalcogen containing liquid comprises:
mixing a quantity of a chalcogen and/or a quantity of a chalcogen salt with a quantity of water to make a precursor polychalcogen liquid;
heating the precursor polychalcogen liquid to a predetermined temperature; and
stirring for a predetermined time.

3. The method of claim 2, wherein the polychalcogen liquid comprises a polysulfide liquid, and the chalcogen is sulfur.

4. The method of claim 2, wherein the polychalcogen liquid comprises a polytelluride liquid, and the chalcogen is tellurium.

5. The method of claim 2, wherein the polychalcogen liquid comprises a polyselenide liquid and the chalcogen is selenium.

6. The method of claim 1, wherein preparing the graphene nanoplatelet containing liquid comprises:
mixing a quantity of graphene nanoplatelets with a quantity of water to make a precursor graphene nanoplatelet containing liquid;
heating the precursor graphene nanoplatelet containing liquid to a predetermined temperature; and
dispersing said liquid using high energy methods (such as bath sonication, probe sonication, cavitation, ball milling, and stirring) for a predetermined amount of time.

7. The method of claim 1, wherein preparing the acid-based liquid further comprises:
dissolving acid in water to make an acid mixture having a desired acid concentration;
cooling the acid mixture to a predetermined temperature; and
adding cold water to the acid mixture to reach a specific concentration.

8. The method of claim 1, further comprising:
cooling a quantity of water to a predetermined temperature;
mixing in the graphene nanoplatelet containing liquid with the water to form a first mixture;
mixing in the polychalcogen containing liquid with the first mixture;
mixing in ethylene diamine with the first mixture;
mixing in ethanol with the first mixture;
determining that a temperature of the first mixture is within a predetermined temperature range; and
mixing the acid-based liquid into the first mixture.

9. The method of claim 1, wherein filtering the mixture to produce the filtrate further comprises rinsing the filtrate with water until a certain pH is reached.

10. The method of claim 1, wherein drying the filtrate to produce the active material further comprises:
placing the filtrate in an oven for a predetermine time and/or at a first predetermined temperature;
heat treating the filtrate by placing the filtrate in a furnace for a predetermined time and/or at a second predetermined temperature,
wherein a gas composition within the furnace is substantially inert and can be argon.

11. An active material comprising a chalcogen, and graphene nanoplatelets.

12. The active material of claim 11, wherein the graphene nanoplatelets and/or the chalcogen form a complex with an amine.

13. The active material of claim 12, wherein the complex is granted using a noncovalent interaction between amine functional groups and at least one of the graphene nanoplatelets and the chalcogen.

14. The active material of claim 11, wherein the graphene nanoplatelets are uniformly dispersed throughout the active material.

15. The active material of claim 14, wherein the uniform dispersion of the graphene nanoplatelets is driven by an amine complexed with the chalcogen.

16. An active material of claim 11, wherein the graphene nanoplatelets are decorated with an amine.

17. The active material of claim 11, wherein a concentration of chalcogen within the active material is between 30% and 95% by weight.

18. The active material of claim 11, wherein a concentration of the graphene nanoplatelets is between 5% and 70% by weight.

19. The active material of claim 11, wherein an amine is selected from but not limited to:
EDA, EDTA, cadaverine, putrescine, diamines, triamines and mixtures thereof.

20. The active material of claim 11, wherein a particle size range of the chalcogen ranges from 1 nm to 1000 nm.

21. The active material of claim 11, wherein particle size range of the graphene nanoplatelets range from 1 μm to 1000 μm.

22. The active material of claim 11, wherein the chalcogen is sulfur.

23. The active material of claim 11, wherein the chalcogen comprises two elements, a primary chalcogen element and a secondary chalcogen element, the primary chalcogen element comprising sulfur; and the secondary chalcogen element comprising tellurium, selenium, another chalcogen element, a post-transition metal or mixtures thereof.

24. The active material of claim 23, wherein a concentration of the secondary chalcogen element ranges from 1% to 30% by weight.
